(19) United States
(12) Patent Application Publication
(10) Pub. No.: US 2004/0196133 A1
(43) Pub. Date: Oct. 7, 2004

(54) Thermal fuse having a function of a current fuse

(75) Inventor: Toshiro Kawanishi, Osaka (JP)

Correspondence Address: AKIN GUMP STRAUSS HAUER & FELD L.L.P., ONE COMMERCE SQUARE, 2005 MARKET STREET, SUITE 2200, PHILADELPHIA, PA, 19103-7013, US

(73) Assignee: Uchihashi Estec Co., Ltd.

(21) Appl. No.: 10/805,700

(22) Filed: Mar. 22, 2004

(30) Foreign Application Priority Data
Apr. 3, 2003 (JP) P2003-099783

(51) Int. Cl. H01H 85/04

(52) U.S. Cl. 337/159; 337/290

(57) ABSTRACT

A thin thermal fuse is provided with a rush current resistance performance so as to be usable also as a current fuse. In a thermal fuse in which a low-melting fusible alloy piece 2 having an alloy composition containing 40 to 70% Bi is connected between a pair of flat lead conductors 1, 1, a flux 4 is applied to the low-melting fusible alloy piece 2, and the piece is sandwiched between a resin base film 31 and a resin cover film 32 to provide insulation, the resistance of the low-melting fusible alloy piece 2 is set so as to enable the low-melting fusible alloy piece 2 to be fused off also by Joule heat due to an allowable maximum current of a secondary battery.

### BACKGROUND OF THE INVENTION

1. Field of the Invention

The present invention relates to a thin thermal fuse having a function of a current fuse.

In a secondary battery which is useful as a power source for a portable apparatus such as a notebook computer or a portable telephone, particularly, a lithium-ion secondary battery or a lithium polymer secondary battery, the heating temperature in an abnormal state is high because of its high energy density. Therefore, a battery circuit must be interrupted at an allowable maximum temperature of 85 to 95° C. so as to prevent an accident such as explosion from occurring in the battery.

2. Description of the Prior Art

Such a protector is requested to be thin in order to realize mounting into a battery pack. Therefore, a thin thermal fuse such as shown in FIG. 4 or 5 is used in a protector.

In FIG. 4, 31′ denotes a resin base film, and 1′, 1′ denote flat lead conductors in each of which a front end portion is secured to the rear face of the base film 31′ and a part 100′ of the front end portion is exposed from the upper face of the base film 31′. The reference numeral 2′ denotes a fuse element which is bonded between the exposed parts 100′, 100′ of the two flat lead conductors 1′ 1′ by welding or the like, 32 denotes a resin cover film in which a peripheral portion is sealingly attached to the base film 31′ that is horizontally held, and 4′ denotes a flux which is applied to the periphery of the fuse element 2′.

Referring to FIG. 5, 1′, 1′ denote flat lead conductors, and 2′ denotes a fuse element which is bonded between the upper faces of tip end portions of the two lead conductors 1′, 1′ by welding or the like. The reference numerals 31′ and 32′ denote a resin base film and a resin cover film, respectively. Tip end portions of the flat lead conductors 1′, 1′, and the fuse element 2′ are sandwiched between the films, and a peripheral portion of the resin cover film 32′ is sealingly attached to the resin base film 31′. The reference numeral 4′ denotes a flux.

Such a thermal fuse is placed so as to be thermally in contact with the body of a secondary battery. When the battery is caused to generate heat by any abnormality, a fuse element alloy of the thermal fuse is melted by the generated heat, and the molten alloy is divided and spheroidized because of the wettability with respect to the lead conductors or electrodes under the coexistence with the activated flux that has already melted. A battery circuit is interrupted as a result of advancement of the spheroid division.

In a secondary battery, an overcurrent of about 2 to 10 A sometimes flows for a long time period (about 1,000 seconds) , thereby causing the battery to enter a dangerous state. A current fuse which operates at such an overcurrent is often used in the battery pack. In such a protection system, however, a current fuse is required in addition to a thermal fuse, and a large accommodation space must be ensured in the battery pack. Therefore, the system fails to fulfill the request of miniaturization of a battery pack, and hence is disadvantageous to a use in a portable apparatus.

In a conventional thin thermal fuse, the fuse body has a thickness of about 1.1 mm. Consequently, the sectional area of a fuse element, i.e., a low-melting fusible alloy piece is made small so that the resistance of the fuse element can be set to be relatively high. Therefore, Joule heat under the overcurrent of 2 to 10 A and 1,000 seconds enable the temperature of the fuse element to be raised to the melting point, thereby causing the fuse element to be fused off. Namely, such a thermal fuse may be expected also to exert a function of a current fuse.

The inventor performed experiments on the use of a thin thermal fuse as a current fuse. However, it was known that a conventional thin thermal fuse operates at a rush current and hence cannot be used also as a current fuse.

A rush current momentarily flows when a power supply is turned on, because of a transient phenomenon or a low circuit resistance at the turning-on due to the low temperature. In such a secondary battery, a rush current of about 50 to 100 A flows for 5 ms. A conventional thin thermal fuse operates at a rush current of this level, and therefore is hardly usable also as a current fuse. For example, a conventional thin thermal fuse in which a low-melting fusible alloy piece having an alloy composition of 43In-41Sn-13Cd-3Bi is used operates at a rush current of this level, and therefore cannot be used also as a current fuse.

The assignee of the present invention has already proposed a thin thermal fuse of an operating temperature of 85 to 95° C. in which an alloy composition of 45 to 55% Bi and the balance In is used as a fuse element (Japanese Patent Application Laying-Open No. 2002-150906).

In the proposed thin thermal fuse, in order to prevent the operating temperature from being shifted by Joule heat of the fuse element, the resistance of the fuse element is set to be as low as possible. The fuse element is not intended to be fused off by the above-mentioned overcurrent of about 2 to 10 A and 1,000 seconds, or to be heated to the melting point.

However, the inventor has known that, in a thermal fuse in which a fuse element of an alloy containing a large amount of Bi is used, the high specific resistance of the alloy participates advantageously in the rush current resistance performance, and the thermal fuse suitably functions also as a current fuse for an overcurrent of the above-mentioned level, or about 2 to 10 A and 1,000 seconds. Namely, the inventor has known that a thin thermal fuse having a fuse element of 52In-48Bi in which the specific resistance is about 1.6 times that of a conventional fuse element (43In-41Sn-13Cd-3Bi is used as the alloy composition of the fuse element) does not operate at a rush current of the above level, and can be satisfactorily used as a current fuse.

The reason of the above is considered as follows.

When a thin thermal fuse is energized, an approximate temperature rise process of a fuse element can be deemed as a phenomenon that part of Joule heat of the fuse element is absorbed by the thermal capacity of the fuse element, and the amount of heat which has not been absorbed is dissipated through flat lead conductors. In this case, when the current is indicated by i, the electric resistance of the fuse element is indicated by r, the heat dissipation resistance of the flat lead conductors is indicated by R, and the thermal capacity of the fuse element is indicated by C, the temperature rise T of the fuse element is given by:

T=Ri²r(1−e^{-t/RC}) (1)

When the melting point of the fuse element is indicated by Tₘ, and the normal temperature is indicated by T₀, the operation characteristics of the current i and the operating time t can be obtained by setting T=(Tm−T₀) in Expression (1), and the following expression holds:

i=(Tm−T₀)^{1/2}/[RC(1−e^{-t/RC})]^{1/2} (2)

In FIG. 3, the curve A shows the operation characteristics of a thin thermal fuse in which 52In-48Bi is used as a fuse element, and the curve B shows those of a conventional thin thermal fuse.

In FIG. 3, the current i_{P} shows the above-mentioned rush current (the current value: i_{P}, the duration time period: 5 ms). At the rush current, the thin thermal fuse in which 52In-48Bi is used as a fuse element does hot operate at the rush current, and the conventional thin thermal fuse operates.

The reason of this is estimated as follows. In the thin thermal fuse in which 52In-48Bi having a large specific resistance is used as the fuse element, the volume of the low-melting fusible alloy piece is larger than that in the conventional thin thermal fuse. As a result, C in Expression (1) above is increased, and the operating current-time curve is shifted from the curve B to the curve A. Namely, the heat absorption of the fuse element largely participates in the transient state of the temperature rise due to Joule heat of the fuse element in the thin thermal fuse. When the sectional area of the fuse element is adequately increased to enhance the heat absorption ability, the temperature rise of the fuse element under a rush current can be suppressed to the melting point of the fuse element or lower.

### SUMMARY OF THE INVENTION

It is an object of the invention to provide a thin thermal fuse with a rush current resistance performance to enable the thin thermal fuse to be used also as a current fuse.

A thermal fuse having a function of a current fuse according to a first aspect of the invention is a thermal fuse in which a low-melting fusible alloy piece having an alloy composition containing 40 to 70% Bi is connected between a pair of flat lead conductors, a flux is applied to the low-melting fusible alloy piece, and the flux-applied low-melting fusible alloy piece is sandwiched between a resin base film and a resin cover film to provide insulation, wherein a resistance of the low-melting fusible alloy piece is set so as to enable the low-melting fusible alloy piece to be fused off also by Joule heat due to an allowable maximum current of a secondary battery.

A thermal fuse having a function of a current fuse according to a second aspect of the invention is characterized in that, in the thin thermal fuse having a function of a current fuse according to the first aspect of the invention, a melting point of the low-melting fusible alloy piece is 85 to 95° C., and the allowable maximum current is a current of 2 to 10 A and 1,000 seconds.

A thermal fuse having a function of a current fuse according to a third aspect of the invention is characterized in that, in the thin thermal fuse having a function of a current fuse according to the first or second aspect of the invention, front end portions of the pair of flat lead conductors are secured to a rear face of the resin base film, a part of each of the front end portions is exposed from a surface of the base film, the low-melting fusible alloy piece is connected between the exposed parts, the flux is applied to the low-melting fusible alloy piece, and an area above the base film is sealed by the resin cover film.

A thermal fuse having a function of a current fuse according to a fourth aspect of the invention is characterized in that, in the thin thermal fuse having a function of a current fuse according to the first or second aspect of the invention, the pair of flat lead conductors, and the flux-applied low-melting fusible alloy piece which is connected between upper faces of tip end portions of the lead conductors are sealed with being vertically sandwiched between the resin cover film and the resin base film.

A thermal fuse having a function of a current fuse according to a fifth aspect of the invention is characterized in that, in the thin thermal fuse having a function of a current fuse according to any one of the first to fourth aspects of the invention, a balance of the alloy composition containing 40 to 70% Bi is In and inevitable impurities.

A thermal fuse having a function of a current fuse according to a sixth aspect of the invention is characterized in that, in the thin thermal fuse having a function of a current fuse according to any one of the first to fourth aspects of the invention, a balance of the alloy composition containing 40 to 70% Bi is In, inevitable impurities, and 0.05 to 5% of at least one of Ag, Cu, Au, Sb, Ni, Pt, Pd, Ge, and P.

A thermal fuse having a function of a current fuse according to a seventh aspect of the invention is characterized in that, in the thin thermal fuse having a function of a current fuse according to any one of the first to sixth aspects of the invention, a resistance of the low-melting fusible alloy piece is 4.5 to 50 mΩ.

A thermal fuse having a function of a current fuse according to an eighth aspect of the invention is characterized in that, in the thin thermal fuse having a function of a current fuse according to any one of the first to seventh aspects of the invention, a ratio d/t of an outer diameter d of the low-melting fusible alloy piece to a thickness t of each of the flat lead conductors is 2 to 5.

A thermal fuse having a function of a current fuse according to a ninth aspect of the invention is characterized in that, in the thin thermal fuse having a function of a current fuse according to any one of the first to eighth aspects of the invention, a thickness from a lower face of the resin base film to an upper face of the resin cover film is 2.0 mm or smaller.

A thermal fuse having a function of a current fuse according to a tenth aspect of the invention is characterized in that, in the thin thermal fuse having a function of a current fuse according to any one of the first to ninth aspects of the invention, the flat lead conductors are made of nickel or an iron alloy.

### BRIEF DESCRIPTION OF THE DRAWINGS

FIG. 1 is a view showing an embodiment of a thermal fuse having a function of a current fuse according to a third aspect of the invention;

FIG. 2 is a view showing an embodiment of a thermal fuse having a function of a current fuse according to a fourth aspect of the invention;

FIG. 3 is a view showing results of measurements of operation characteristics of a thermal fuse having a function of a current fuse according to the invention, and a conventional thin thermal fuse;

FIG. 4 is a view showing an example of a conventional thin thermal fuse; and

FIG. 5 is a view showing another example of a conventional thin thermal fuse.

### DETAILED DESCRIPTION OF THE PREFERRED EMBODIMENT

### Embodiment of the Invention

Hereinafter, embodiments of the invention will be described with reference to the accompanying drawings.

The thin thermal fuse having a function of a current fuse according to the invention is a thermal fuse in which a low-melting fusible alloy piece having an alloy composi- tion containing 40 to 70% Bi is connected between a pair of flat lead conductors, a flux is applied to the low-melting fusible alloy piece, the flux-applied low-melting fusible alloy piece is sandwiched between a resin base film and a resin cover film to provide insulation. The thermal fuse is used as a protector for a secondary battery such as a lithium-ion secondary battery or a lithium polymer secondary battery, in a state where the thermal fuse is thermally in contact with the battery. The melting point and resistance of the low-melting fusible alloy piece are set so that the low-melting fusible alloy piece is fused off when the temperature of the battery is raised to an allowable maximum temperature of 85 to 95° C., or when the current reaches an allowable maximum of 50 to 100 A and 1,000 s.

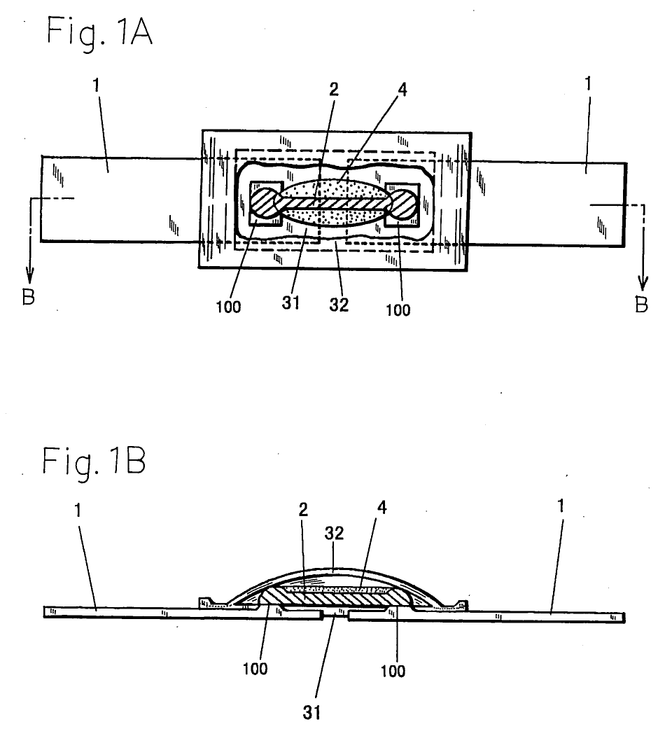

In FIG. 1, (A) is a plan view showing an embodiment of a thin thermal fuse according to a third aspect of the invention, in partial section, and (B) is a section view taken along the line B-B in (A) of FIG. 1.

In FIG. 1, 31 denotes a resin base film, and 1, 1 denote flat lead conductors in each of which a front end portion is secured to the rear face of the base film 31 and a part 100 of the front end portion is exposed from the upper face of the base film 31. The reference numeral 2 denotes a fuse element which is bonded between the exposed parts 100, 100 of the two flat lead conductors 1, 1 by welding or the like. In the welding process, spot resistance welding or laser welding can be used. The reference numeral 32 denotes a resin cover film in which a peripheral portion is sealingly attached to the base film 31 that is horizontally held, and 4 denotes a flux which is applied to the periphery of the fuse element 2.

The part of the front end portion of each of the flat lead conductors can be exposed from the surface of the base film 31 by a method in which a projection is previously formed in the front end portion of the flat lead conductor by a drawing process, the front end portion of the flat lead conductor is fusion-bonded to the rear face of the base film under heating, and the projection is passed through and fusion-bonded to the base film. Alternatively, another method may be employed in which the front end portion of the flat lead conductor is fusion-bonded to the rear face of the base film under heating, and the part of the front end portion of the lead conductor is exposed from the surface of the base film by a drawing process.

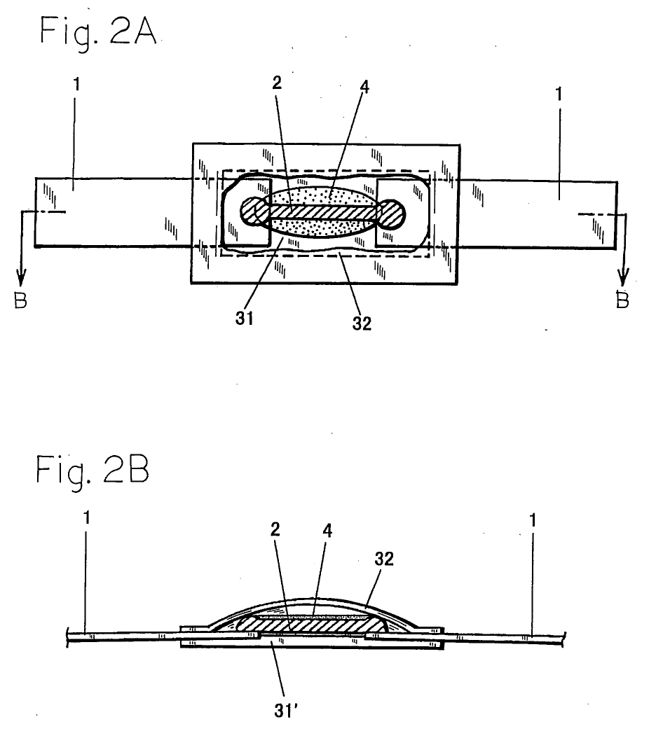

In FIG. 2, (A) is a plan view showing an embodiment of a thin thermal fuse according to a fourth aspect of the invention, in partial section, and (B) is a section view taken along the line B-B in (A) of FIG. 2.

In FIG. 2, 1, 1 denote flat lead conductors, and 2 denotes a fuse element which is bonded between the upper faces of tip end portions of the two flat lead conductors 1, 1 by welding or the like. In the welding process, spot resistance welding or laser welding can be used. The reference numeral 31 denotes a resin base film, and 32 denotes a resin cover film. The front end portions of the two flat lead conductors 1, 1, and the fuse element 2 are sandwiched between the resin films 31, 32, and a peripheral portion of the resin cover film 32 is sealingly attached to the resin base film 31 which is horizontally held. The reference numeral 4 denotes a flux which is applied to the periphery of the fuse element 2.

The thermal fuse having a function of a current fuse shown in FIG. 2 can be produced in the following manner. The fuse element is connected between the upper faces of the tip end portions of the two flat lead conductors by spot resistance welding, laser welding, or the like. Then, the front end portions of the two flat lead conductors 1, 1, and the fuse element 2 are sandwiched between the lower and upper resin films 31, 32, and the resin base film 31 is horizontally held on a base. Both end portions of the resin cover film 32 are pressed by a releasing chip such as a ceramic chip to be pressingly in contact with the flat lead conductors, respectively. During the press contacting process, the flat lead conductors may be heated. This heating can be conducted by electromagnetic induction heating, contacting a heat plate with the lead conductors, or the like. In electromagnetic induction heating, particularly, high-frequency magnetic fluxes interlink with the tip end portions of the lead conductors welded to end portions of the fuse element, via the upper or lower resin film, so that the tip end portions can be intensively heated. Therefore, electromagnetic induction heating is advantageous from the viewpoint of thermal efficiency. Because of the intensive heating, a middle portion of the fuse element which is remote from the end portions of the fuse element can be sufficiently suppressed from being heated, and hence such heating is safe from the aspect that the original shape of the fuse element is to be reserved.

In the embodiment shown in FIG. 2, the sealing between the flat lead conductors 1 and the resin films 31, 32 can be conducted by fusion bonding in the heating process on the flat lead conductors, and the sealing of the interface in which the lower and upper resin films 31, 32 are in direct contact with each other can be conducted realized by, for example, ultrasonic fusion bonding, high-frequency di-electric heating fusion bonding, or heat plate contact fusion bonding. It does not matter which one of the former fusion bonding and the latter fusion bonding is first conducted. For example, after the latter fusion bonding, the flux may be applied to the low-melting fusible alloy piece, and the former fusion bonding may be then conducted.

In the case where the thermal fuse having a function of a current fuse of the invention is energized by a current i under the external temperature To, when the resistance of the fuse element is indicated by r, the thermal capacity of the fuse element is indicated by C, and the thermal resistance of the lead conductors is indicated by R, the temperature Tx of the fuse element is given by:

Tx=T₀+Ri²r(1−e^{-t/RC}) (3)

The relationship between the current i and the time t when the thermal fuse having a function of a current fuse operates, i.e., when the temperature of the fuse element reaches the melting point Tm is given by:

i=(Tm−T₀)^{1/2}/[Rr(1−e^{-t/RC})]^{1/2} (4)

In the thermal fuse having a function of a current fuse of the invention, the resistance r of the fuse element is set so that the fuse does not operate at a rush current of 50 to 100 A and 5 ms, but operates at an allowable maximum current of 2 to 10 A and 1,000 s.

The melting point Tm of the fuse element is determined by the allowable maximum temperature of the battery, and also R (the thermal resistance of the flat lead conductors) is determined by the material of the flat lead conductors. Therefore, the resistance r of the fuse element is set so that the allowable maximum current i is 2 to 10 A at t=1,000 S.

When the specific resistance of the fuse element is indicated by ρ, the diameter of the fuse element is indicated by d, and the length of the fuse element is indicated by L, the resistance r of the fuse element is given by:

r=4ρL/(πd²) (5)

In the thermal fuse having a function of a current fuse of the invention, an alloy containing 40 to 70% Bi is used as the fuse element, and hence the specific resistance ρ is high. As compared with the conventional art example in which the specific resistance ρ is low, therefore, the diameter d of the fuse element is inevitably made larger in order to set the given resistance r. As a result, the thermal capacity C of the fuse element is large, and, as compared with the characteristic curve of the case where C is small, the temperature drop in the initial stage is therefore gentler, so that an operation at a rush current can be avoided.

Consequently, the allowable maximum current for a short-time current of t=about 5 ms can be made higher without causing the operating current at t=1,000 s to be varied, so that the rush current resistance performance can be ensured.

The cut-off current io with respect to a current which continues for a long time period of, for example, 1,000 s can be obtained by setting t→∞ in Expression (4), and the following expression holds:

i₀=(Tm−T₀)^{1/2}/(Rr)^{1/2} (6)

Under the same cut-off current i₀, the resistance r of the fuse element can be made lower as R (the thermal resistance of the flat lead conductors) is higher. As apparent from Expression (5), as the resistance r is lower, the diameter d of the fuse element can be made larger, so that the thermal capacity C of the fuse element can be made larger and the rush current resistance performance can be enhanced. Therefore, nickel or an iron alloy having a high thermal specific resistance is preferably used in the flat lead conductors. In this case, in order to lower the interface resistance of the bonding interfaces (usually, welding interfaces) between the flat lead conductors and the fuse element, preferably, a thin film of Cu or Ag is disposed at least in the bonding face of each of the flat lead conductors to form an alloy layer of Cu or Ag and the base material in the interface.

It is a matter of course that copper can be used in the flat lead conductors.

In the thermal fuse having a function of a current fuse of the invention, the amount of Bi in the alloy composition of the fuse element is set to 40 to 70% for the following reason. When the amount is smaller than 40%, the specific resistance is so low that the above-mentioned advantage cannot be satisfactorily attained. When the amount is larger than 70%, the specific resistance is too high, and the outer diameter of the fuse element is excessively large. Therefore, the thickness of the body of the thermal fuse having a function of a current fuse, i.e., the height from the lower face of the resin base film to the upper face of the resin cover film is hardly maintained to 2 mm or smaller (the thinness cannot be maintained). Furthermore, it is difficult to conduct a drawing process.

In the invention, the use of an alloy composition of 40 to 70% Bi and the balance In is advantageous to setting of the melting point of the fuse element to 85 to 95° C., and assurance of smooth drawability.

The rush current flows for a very short time period or for about 5 ms, and in an impulsive manner, and hence the fuse element is impulsively heated. Therefore, 0.05 to 5% of at least one of Ag, Cu, Au, Sb, Ni, Pt, Pd, Ge, and P may be added to the alloy composition to enhance the mechanical strength by solid solution hardening, whereby the resistance of the fuse element against a thermal shock due to a rush current can be improved. The addition amount is set to 0.05 to 5% for the following reason. When the addition amount is smaller than 0.05%, the effect of the addition cannot be attained. When the addition amount is larger than 5%, the melting point and specific resistance of the fuse element are largely varied.

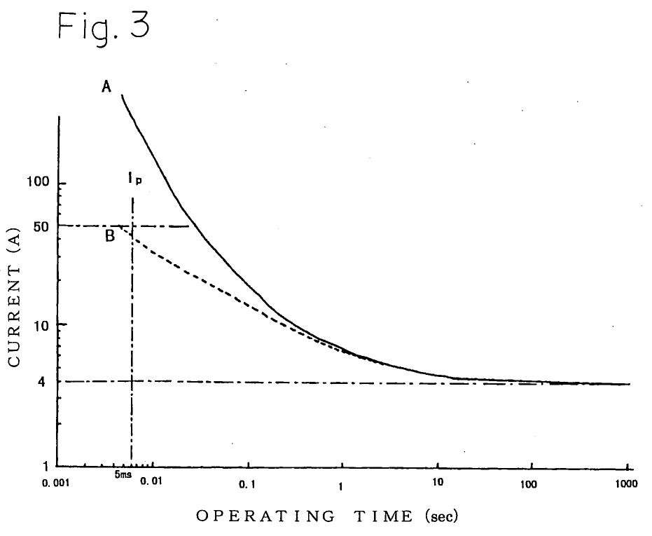

In the cut-off current-operating time characteristic shown in FIG. 3, the transient state region in the vicinity of t=0 participates in the rush current resistance performance. A portion of a flat lead conductor which thermally participates in the transient state is a small restricted portion including the portion to which an end portion of the fuse element is bonded. In the time constant RC, therefore, R (the thermal resistance of the flat lead conductors) does not depend on the width of the conductor, and is in inverse proportion to the thickness h, and C is in proportion to the diameter d of the fuse element. Therefore, RC can be evaluated in terms of d/h. Usually, d/h is set to 2 to 4.

The sectional area of the fuse element is set to 0.032 to 0.33 mm². The sectional shape of the fuse element may have a circular shape, or a flat shape. In the latter case, d is the diameter of a circle having the same sectional area.

In the thermal fuse having a function of a current fuse of the invention, the resistance r of the fuse element is restricted by the allowable maximum current (1,000 s, 2 to 10 A), and set to 4.5 to 50 mΩ as described above. The temperature rise ΔT of the fuse element under the rating current I can be obtained by setting i→I and t→∞ in Expression (4), and the following expression holds:

ΔT=RI²r (7)

When I is set to I=1 A, ΔT is 2° C. in the case where nickel conductors are used as the flat lead conductors. In the case where copper lead conductors are used, the temperature rise can be made smaller. Therefore, the degree of the shift of the operating temperature when the fuse operates as a thermal fuse can be made sufficiently small.

The fuse element can be usually produced by a method in which a billet is produced, the billet is shaped into a stock wire by an extruder, and the stock wire is drawn by a dice to a wire. The wire can be finally passed through calender rolls so as to be used as a flat wire.

Alternatively, the fuse element may be produced by the rotary drum spinning method in which a cylinder containing cooling liquid is rotated, the cooling liquid is held in a layer-like manner by a rotational centrifugal force, and a molten material jet ejected from a nozzle is introduced into the cooling liquid layer to be cooled and solidified, thereby obtaining a thin wire member.

In the production, the alloy composition is allowed to contain inevitable impurities which are produced in productions of metals of raw materials and also in melting and stirring of the raw materials.

As the resin films (the resin base film, the resin cover film), useful is a plastic film having a thickness of about 100 to 500 μm. Examples of such a film are engineering plastics such as polyethylene terephtalate, polyethylene naphtalate, polyamide, polyimide, polybutylene terephtalate, polyphenylene oxide, polyethylene sulfide, and polysulfone, engineering plastics such as polyacetal, polycarbonate, polyphenylene sulfide, polyoxybenzoyl, polyether ether ketone, and polyether imide, polypropylene, polyvinyl chloride, polyvinyl acetate, polymethyl methacrylate, polyvinylidene chloride, polytetrafluoroethylene, ethylene-polytetrafluoroethylene copolymer, ethylene-vinyl acetate copolymer (EVA) , AS resin, ABS resin, ionomer, AAS resin, and ACS resin.

As the flux, a natural rosin, a modified rosin (for example, a hydrogenated rosin, an inhomogeneous rosin, or a polymerized rosin), or a purified rosin thereof to which wax, hydrochloride of diethylamine, hydrobromide of diethylamine, and the like are added can be used.

In a preferred embodiment of the invention, the composition of the low-melting fusible alloy piece: 47 to 49% Bi and the balance In, the sectional area of the low-melting fusible alloy piece: 0.10 to 0.12 mm², the thickness of the flat lead conductors: 0.10 to 0.20 mm, the thickness of the body portion: 1.1 to 1.3 mm, the resistance of the low-melting fusible alloy piece: 15 to 16 mΩ, and the nominal operating temperature: 93° C.

### EXAMPLE

The fuse of the example is a thermal fuse having a function of a current fuse of the configuration shown in FIG. 1. A film of polyethylene terephtalate having a thickness of 200 μm, a width of 4 mm, and a length of 7.5 mm was used as the resin base film 31 and the resin cover film 32. Copper conductors having a thickness of 150 μm, a width of 3 mm, and a length of 15 mm were used as the flat lead conductors 1. A circular wire having a composition of 52In-48Bi, a sectional area of 0.113 mm², and a length of 5 mm was used as the fuse element 2. The distance between the welded portions of the fuse element 2 was set to 3.0 mm. A mixture of a rosin and wax was used as the flux. The thickness of the body portion was 1.2 mm, the resistance was 15.7 mΩ, and the nominal operating temperature was 93° C.

### Comparative Example

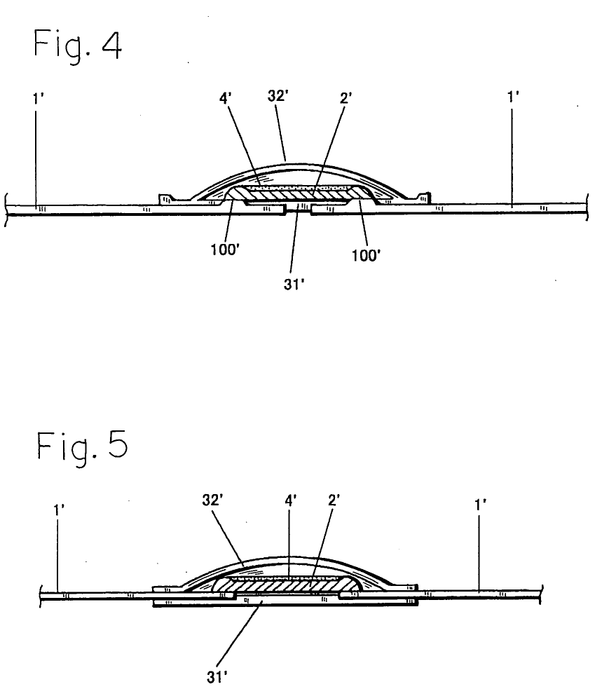

The fuse of the comparative example is a thin thermal fuse of the configuration shown in FIG. 4. A film of poly-ethylene terephtalate having a thickness of 200 μm, a width of 4 mm, and a length of 7.5 mm was used as the resin base film 31′ and the resin cover film 32′. Copper conductors having a thickness of 150 μm, a width of 3 mm, and a length of 15 mm were used as the flat lead conductors 1′. A circular wire having a composition of 43In-41Sn-13Cd-3Bi, a sectional area of 0.071 mm², and a length of 5 mm was used as the fuse element 2′. The distance between the welded portions of the fuse element 2′ was set to 3.0 mm. A mixture of a rosin and wax was used as the flux. The thickness of the body portion was 1.1 mm, the resistance was 15.7 mΩ, and the nominal operating temperature was 93° C.

The operation characteristics of the fuses of the example and the comparative example under room temperature were measured, and results shown in FIG. 3 were obtained. The curve A shows the operation characteristics of the fuse of the example, and the curve B shows those of the fuse of the comparative example.

In both the fuses, the operating current at 1,000 s is about 4 A. In the fuse of the comparative example, the operating current at 5 ms is 50 A or smaller, and the provability that the fuse operates at the above-mentioned rush current is high. By contrast, in the fuse of the example, the operating current at 5 ms is larger than 100 A, and does not operate at the above-mentioned rush current. Therefore, the thermal fuse of the invention can be used also as a current fuse for an allowable maximum current. Although the thickness is increased (1.2 mm of the example in contrast to 1.1 mm of the comparative example), the degree of the increase is very small.

Effects of the Invention

In the thermal fuse having a function of a current fuse according to the invention, even when the thickness or the operating temperature is shifted, the degree of the shift can be suppressed to a low level, and an operation at a rush current can be avoided. Therefore, the thermal fuse can be suitably used also as a current fuse. Consequently, the thermal fuse is very useful as a protector for a secondary battery in which protections with respect to both the allowable maximum temperature and the allowable maximum current are required.

What is claimed is:

1. A thermal fuse having a function of a current fuse in which a low-melting fusible alloy piece having an alloy composition containing 40 to 70% Bi is connected between a pair of flat lead conductors, a flux is applied to said low-melting fusible alloy piece, and said flux-applied low-melting fusible alloy piece is sandwiched between a resin base film and a resin cover film to provide insulation, wherein
a resistance of said low-melting fusible alloy piece is set so as to enable said low-melting fusible alloy piece to be fused off also by Joule heat due to an allowable maximum current of a secondary battery.

2. A thermal fuse having a function of a current fuse according to claim 1, wherein a melting point of said low-melting fusible alloy piece is 85 to 95° C., and the allowable maximum current is a current of 2 to 10 A and 1,000 seconds.

3. A thermal fuse having a function of a current fuse according to claim 1, wherein front end portions of said pair of flat lead conductors are secured to a rear face of said resin base film, a part of each of said front end portions is exposed from a surface of said base film, said low-melting fusible alloy piece is connected between said exposed parts, the flux is applied to said low-melting fusible alloy piece, and an area above said base film is sealed by said resin cover film.

4. A thermal fuse having a function of a current fuse according to claim 2, wherein front end portions of said pair of flat lead conductors are secured to a rear face of said resin base film, a part of each of said front end portions is exposed from a surface of said base film, said low-melting fusible alloy piece is connected between said exposed parts, the flux is applied to said low-melting fusible alloy piece, and an area above said base film is sealed by said resin cover film.

5. A thermal fuse having a function of a current fuse according to claim 1, wherein said pair of flat lead conductors, and said flux-applied low-melting fusible alloy piece which is connected between upper faces of tip end portions of said lead conductors are sealed with being vertically sandwiched between said resin cover film and said resin base film.

6. A thermal fuse having a function of a current fuse according to claim 2, wherein said pair of flat lead conductors, and said flux-applied low-melting fusible alloy piece which is connected between upper faces of tip end portions of said lead conductors are sealed with being vertically sandwiched between said resin cover film and said resin base film.

7. A thermal fuse having a function of a current fuse according to claim 1, wherein a balance of the alloy composition containing 40 to 70% Bi is In and inevitable impurities.

8. A thermal fuse having a function of a current fuse according to claim 2, wherein a balance of the alloy composition containing 40 to 70% Bi is In and inevitable impurities.

9. A thermal fuse having a function of a current fuse according to claim 3, wherein a balance of the alloy composition containing 40 to 70% Bi is In and inevitable impurities.

10. A thermal fuse having a function of a current fuse according to claim 4, wherein a balance of the.alloy composition containing 40 to 70% Bi is In and inevitable impurities.

11. A thermal fuse having a function of a current fuse according to claim 5, wherein a balance of the alloy composition containing 40 to 70% Bi is In and inevitable impurities.

12. A thermal fuse having a function of a current fuse according to claim 6, wherein a balance of the alloy composition containing 40 to 70% Bi is In and inevitable impurities.

13. A thermal fuse having a function of a current fuse according to claim 1, wherein a balance of the alloy composition containing 40 to 70% Bi is In, inevitable impurities, and 0.05 to 5% of at least one of Ag, Cu, Au, Sb, Ni, Pt, Pd, Ge, and P.

14. A thermal fuse having a function of a current fuse according to claim 2, wherein a balance of the alloy composition containing 40 to 70% Bi is In, inevitable impurities, and 0.05 to 5% of at least one of Ag, Cu, Au, Sb, Ni, Pt, Pd, Ge, and,P.

15. A thermal fuse having a function of a current fuse according to claim 3, wherein a balance of the alloy composition containing 40 to 70% Bi is In, inevitable impurities, and 0.05 to 5% of at least one of Ag, Cu, Au, Sb, Ni, Pt, Pd, Ge, and P.

16. A thermal fuse having a function of a current fuse according to claim 4, wherein a balance of the alloy composition containing 40 to 70% Bi is In, inevitable impurities, and 0.05 to 5% of at least one of Ag, Cu, Au, Sb, Ni, Pt, Pd, Ge, and P.

17. A thermal fuse having a function of a current fuse according to claim 5, wherein a balance of the alloy composition containing 40 to 70% Bi is In, inevitable impurities, and 0.05 to 5% of at least one of Ag, Cu, Au, Sb, Ni, Pt, Pd, Ge, and P.

18. A thermal fuse having a function of a current fuse according to claim 6, wherein a balance of the alloy composition containing 40 to 70% Bi is In, inevitable impurities, and 0.05 to 5% of at least one of Ag, Cu, Au, Sb, Ni, Pt, Pd, Ge, and P.

19. A thermal fuse having a function of a current fuse according to claim 1, wherein a resistance of said low-melting fusible alloy piece is 4.5 to 50 mΩ.

20. A thermal fuse having a function of a current fuse according to claim 2, wherein a resistance of said low-melting fusible alloy piece is 4.5 to 50 mΩ.

21. A thermal fuse having a function of a current fuse according to claim 3, wherein a resistance of said low-melting fusible alloy piece is 4.5 to 50 mΩ.

22. A thermal fuse having a function of a current fuse according to claim 4, wherein a resistance of said low-melting fusible alloy piece is 4.5 to 50 mΩ.

23. A thermal fuse having a function of a current fuse according to claim 5, wherein a resistance of said low-melting fusible alloy piece is 4.5 to 50 mΩ.

24. A thermal fuse having a function of a current fuse according to claim 6, wherein a resistance of said low-melting fusible alloy piece is 4.5 to 50 mΩ.

25. A thermal fuse having a function of a current fuse according to claim 7, wherein a resistance of said low-melting fusible alloy piece is 4.5 to 50 mΩ.

26. A thermal fuse having a function of a current fuse according to claim 8, wherein a resistance of said low-melting fusible alloy piece is 4.5 to 50 mΩ.

27. A thermal fuse having a function of a current fuse according to claim 9, wherein a resistance of said low-melting fusible alloy piece is 4.5 to 50 mΩ.

28. A thermal fuse having a function of a current fuse according to claim 10, wherein a resistance of said low-melting fusible alloy piece is 4.5 to 50 mΩ.

29. A thermal fuse having a function of a current fuse according to claim 11, wherein a resistance of said low-melting fusible alloy piece is 4.5 to 50 mΩ.

30. A thermal fuse having a function of a current fuse according to claim 12, wherein a resistance of said low-melting fusible alloy piece is 4.5 to 50 mΩ.

31. A thermal fuse having a function of a current fuse according to claim 13, wherein a resistance of said low-melting fusible alloy piece is 4.5 to 50 mΩ.

32. A thermal fuse having a function of a current fuse according to claim 14, wherein a resistance of said low-melting fusible alloy piece is 4.5 to 50 mΩ.

33. A thermal fuse having a function of a current fuse according to claim 15, wherein a resistance of said low-melting fusible alloy piece is 4.5 to 50 mΩ.

34. A thermal fuse having a function of a current fuse according to claim 16, wherein a resistance of said low-melting fusible alloy piece is 4.5 to 50 m

35. A thermal fuse having a function of a current fuse according to claim 17, wherein a resistance of said low-melting fusible alloy piece is 4.5 to 50 mΩ.

36. A thermal fuse having a function of a current fuse according to claim 18, wherein a resistance of said low-melting fusible alloy piece is 4.5 to 50 mΩ.

37. A thermal fuse having a function of a current fuse according to claim 1, wherein a ratio d/t of an outer diameter d of said low-melting fusible alloy piece to a thickness t of each of said flat lead conductors is 2 to 5.

38. A thermal fuse having a function of a current fuse according to claim 2, wherein a ratio d/t of an outer diameter d of said low-melting fusible alloy piece to a thickness t of each of said flat lead conductors is 2 to 5.

39. A thermal fuse having a function of a current fuse according to claim 3, wherein a ratio d/t of an outer diameter d of said low-melting fusible alloy piece to a thickness t of each of said flat lead conductors is 2 to 5.

40. A thermal fuse having a function of a current fuse according to claim 4, wherein a ratio d/t of an outer diameter d of said low-melting fusible alloy piece to a thickness t of each of said flat lead conductors is 2 to 5.

41. A thermal fuse having a function of a current fuse according to claim 5, wherein a ratio d/t of an outer diameter d of said low-melting fusible alloy piece to a thickness t of each of said flat lead conductors is 2 to 5.

42. A thermal fuse having a function of a current fuse according to claim 6, wherein a ratio d/t of an outer diameter d of said low-melting fusible alloy piece to a thickness t of each of said flat lead conductors is 2 to 5.

43. A thermal fuse having a function of a current fuse according to claim 7, wherein a ratio d/t of an outer diameter d of said low-melting fusible alloy piece to a thickness t of each of said flat lead conductors is 2 to 5.

44. A thermal fuse having a function of a current fuse according to claim 8, wherein a ratio d/t of an outer diameter d of said low-melting fusible alloy piece to a thickness t of each of said flat lead conductors is 2 to 5.

45. A thermal fuse having a function of a current fuse according to claim 9, wherein a ratio d/t of an outer diameter d of said low-melting fusible alloy piece to a thickness t of each of said flat lead conductors is 2 to 5.

46. A thermal fuse having a function of a current fuse according to claim 10, wherein a ratio d/t of an outer diameter d of said low-melting fusible alloy piece to a thickness t of each of said flat lead conductors is 2 to 5.

47. A thermal fuse having a function of a current fuse according to claim 11, wherein a ratio d/t of an outer diameter d of said low-melting fusible alloy piece to a thickness t of each of said flat lead conductors is 2 to 5.

48. A thermal fuse having a function of a current fuse according to claim 12, wherein a ratio d/t of an outer diameter d of said low-melting fusible alloy piece to a thickness t of each of said flat lead conductors is 2 to 5.

49. A thermal fuse having a function of a current fuse according to claim 13, wherein a ratio d/t of an outer diameter d of said low-melting fusible alloy piece to a thickness t of each of said flat lead conductors is 2 to 5.

50. A thermal fuse having a function of a current fuse according to claim 14, wherein a ratio d/t of an outer diameter d of said low-melting fusible alloy piece to a thickness t of each of said flat lead conductors is 2 to 5.

51. A thermal fuse having a function of a current fuse according to claim 15, wherein a ratio d/t of an outer diameter d of said low-melting fusible alloy piece to a thickness t of each of said flat lead conductors is 2 to 5.

52. A thermal fuse having a function of a current fuse according to claim 16, wherein a ratio d/t of an outer diameter d of said low-melting fusible alloy piece to a thickness t of each of said flat lead conductors is 2 to 5.

53. A thermal fuse having a function of a current fuse according to claim 17, wherein a ratio d/t of an outer diameter d of said low-melting fusible alloy piece to a thickness t of each of said flat lead conductors is 2 to 5.

54. A thermal fuse having a function of a current fuse according to claim 18, wherein a ratio d/t of an outer diameter d of said low-melting fusible alloy piece to a thickness t of each of said flat lead conductors is 2 to 5.

55. A thermal fuse having a function of a current fuse according to claim 19, wherein a ratio d/t of an outer diameter d of said low-melting fusible alloy piece to a thickness t of each of said flat lead conductors is 2 to 5.

56. A thermal fuse having a function of a current fuse according to claim 20, wherein a ratio d/t of an outer diameter d of said low-melting fusible alloy piece to a thickness t of each of said flat lead conductors is 2 to 5.

57. A thermal fuse having a function of a current fuse according to claim 21, wherein a ratio d/t of an outer diameter d of said low-melting fusible alloy piece to a thickness t of each of said flat lead conductors is 2 to 5.

58. A thermal fuse having a function of a current fuse according to claim 22, wherein a ratio d/t of an outer diameter d of said low-melting fusible alloy piece to a thickness t of each of said flat lead conductors is 2 to 5.

59. A thermal fuse having a function of a current fuse according to claim 23, wherein a ratio d/t of an outer diameter d of said low-melting fusible alloy piece to a thickness t of each of said flat lead conductors is 2 to 5.

60. A thermal fuse having a function of a current fuse according to claim 24, wherein a ratio d/t of an outer diameter d of said low-melting fusible alloy piece to a thickness t of each of said flat lead conductors is 2 to 5.

61. A thermal fuse having a function of a current fuse according to claim 25, wherein a ratio d/t of an outer diameter d of said low-melting fusible alloy piece to a thickness t of each of said flat lead conductors is 2 to 5.

62. A thermal fuse having a function of a current fuse according to claim 26, wherein a ratio d/t of an outer diameter d of said low-melting fusible alloy piece to a thickness t of each of said flat lead conductors is 2 to 5.

63. A thermal fuse having a function of a current fuse according to claim 27, wherein a ratio d/t of an outer diameter d of said low-melting fusible alloy piece to a thickness t of each of said flat lead conductors is 2 to 5.

64. A thermal fuse having a function of a current fuse according to claim 28, wherein a ratio d/t of an outer diameter d of said low-melting fusible alloy piece to a thickness t of each of said flat lead conductors is 2 to 5.

65. A thermal fuse having a function of a current fuse according to claim 29, wherein a ratio d/t of an outer diameter d of said low-melting fusible alloy piece to a thickness t of each of said flat lead conductors is 2 to 5.

66. A thermal fuse having a function of a current fuse according to claim 30, wherein a ratio d/t of an outer diameter d of said low-melting fusible alloy piece to a thickness t of each of said flat lead conductors is 2 to 5.

67. A thermal fuse having a function of a current fuse according to claim 31, wherein a ratio d/t of an outer diameter d of said low-melting fusible alloy piece to a thickness t of each of said flat lead conductors is 2 to 5.

68. A thermal fuse having a function of a current fuse according to claim 32, wherein a ratio d/t of an outer diameter d of said low-melting fusible alloy piece to a thickness t of each of said flat lead conductors is 2 to 5.

69. A thermal fuse having a function of a current fuse according to claim 33, wherein a ratio d/t of an outer diameter d of said low-melting fusible alloy piece to a thickness t of each of said flat lead conductors is 2 to 5.

70. A thermal fuse having a function of a current fuse according to claim 34, wherein a ratio d/t of an outer diameter d of said low-melting fusible alloy piece to a thickness t of each of said flat lead conductors is 2 to 5.

71. A thermal fuse having a function of a current fuse according to claim 35, wherein a ratio d/t of an outer diameter d of said low-melting fusible alloy piece to a thickness t of each of said flat lead conductors is 2 to 5.

72. A thermal fuse having a function of a current fuse according to claim 36, wherein a ratio d/t of an outer diameter d of said low-melting fusible alloy piece to a thickness t of each of said flat lead conductors is 2 to 5.

73. A thermal fuse having a function of a current fuse according to claim 1, wherein a thickness from a lower face of said resin base film to an upper face of said resin cover film is 2.0 mm or smaller.

74. A thermal fuse having a function of a current fuse according to claim 2, wherein a thickness from a lower face of said resin base film to an upper face of said resin cover film is 2.0 mm or smaller.

75. A thermal fuse having a function of a current fuse according to claim 3, wherein a thickness from a lower face of said resin base film to an upper face of said resin cover film is 2.0 mm or smaller.

76. A thermal fuse having a function of a current fuse according to claim 4, wherein a thickness from a lower face of said resin base film to an upper face of said resin cover film is 2.0 mm or smaller.

77. A thermal fuse having a function of a current fuse according to claim 5, wherein a thickness from a lower face of said resin base film to an upper face of said resin cover film is 2.0 mm or smaller.

78. A thermal fuse having a function of a current fuse according to claim 6, wherein a thickness from a lower face of said resin base film to an upper face of said resin cover film is 2.0 mm or smaller.

79. A thermal fuse having a function of a current fuse according to claim 7, wherein a thickness from a lower face of said resin base film to an upper face of said resin cover film is 2.0 mm or smaller.

80. A thermal fuse having a function of a current fuse according to claim 8, wherein a thickness from a lower face of said resin base film to an upper face of said resin cover film is 2.0 mm or smaller.

81. A thermal fuse having a function of a current fuse according to claim 9, wherein a thickness from a lower face of said resin base film to an upper face of said resin cover film is 2.0 mm or smaller.

82. A thermal fuse having a function of a current fuse according to claim 10, wherein a thickness from a lower face of said resin base film to an upper face of said resin cover film is 2.0 mm or smaller.

83. A thermal fuse having a function of a current fuse according to claim 11, wherein a thickness from a lower face of said resin base film to an upper face of said resin cover film is 2.0 mm or smaller.

84. A thermal fuse having a function of a current fuse according to claim 12, wherein a thickness from a lower face of said resin base film to an upper face of said resin cover film is 2.0 mm or smaller.

85. A thermal fuse having a function of a current fuse according to claim 13, wherein a thickness from a lower face of said resin base film to an upper face of said resin cover film is 2.0 mm or smaller.

86. A thermal fuse having a function of a current fuse according to claim 14, wherein a thickness from a lower face of said resin base film to an upper face of said resin cover film is 2.0 mm or smaller.

87. A thermal fuse having a function of a current fuse according to claim 15, wherein a thickness from a lower face of said resin base film to an upper face of said resin cover film is 2.0 mm or smaller.

88. A thermal fuse having a function of a current fuse according to claim 16, wherein a thickness from a lower face of said resin base film to an upper face of said resin cover film is 2.0 mm or smaller.

89. A thermal fuse having a function of a current fuse according to claim 17, wherein a thickness from a lower face of said resin base film to an upper face of said resin cover film is 2.0 mm or smaller.

90. A thermal fuse having a function of a current fuse according to claim 18, wherein a thickness from a lower face of said resin base film to an upper face of said resin cover film is 2.0 mm or smaller.

91. A thermal fuse having a function of a current fuse according to claim 19, wherein a thickness from a lower face of said resin base film to an upper face of said resin cover film is 2.0 mm or smaller.

92. A thermal fuse having a function of a current fuse according to claim 20, wherein a thickness from a lower-face of said resin base film to an upper face of said resin cover film is 2.0 mm or smaller.

93. A thermal fuse having a function of a current fuse according to claim 21, wherein a thickness from a lower face of said resin base film to an upper face of said resin cover film is 2.0 mm or smaller.

94. A thermal fuse having a function of a current fuse according to claim 22, wherein a thickness from a lower face of said resin base film to an upper face of said resin cover film is 2.0 mm or smaller.

95. A thermal fuse having a function of a current fuse according to claim 23, wherein a thickness from a lower face of said resin base film to an upper face of said resin cover film is 2.0 mm or smaller.

96. A thermal fuse having a function of a current fuse according to claim 24, wherein a thickness from a lower face of said resin base film to an upper face of said resin cover film is 2.0 mm or smaller.

97. A thermal fuse having a function of a current fuse according to claim 25, wherein a thickness from a lower face of said resin base film to an upper face of said resin cover film is 2.0 mm or smaller.

98. A thermal fuse having a function of a current fuse according to claim 26, wherein a thickness from a lower face of said resin base film to an upper face of said resin cover film is 2.0 mm or smaller.

99. A thermal fuse having a function of a current fuse according to claim 27, wherein a thickness from a lower face of said resin base film to an upper face of said resin cover film is 2.0 mm or smaller.

100. A thermal fuse having a function of a current fuse according to claim 28, wherein a thickness from a lower face of said resin base film to an upper face of said resin cover film is 2.0 mm or smaller.

101. A thermal fuse having a function of a current fuse according to claim 29, wherein a thickness from a lower face of said resin base film to an upper face of said resin cover film is 2.0 mm or smaller.

102. A thermal fuse having a function of a current fuse according to claim 30, wherein a thickness from a lower face of said resin base film to an upper face of said resin cover film is 2.0 mm or smaller.

103. A thermal fuse having a function of a current fuse according to claim 31, wherein a thickness from a lower face of said resin base film to an upper face of said resin cover film is 2.0 mm or smaller.

104. A thermal fuse having a function of a current fuse according to claim 32, wherein a thickness from a lower face of said resin base film to an upper face of said resin cover film is 2.0 mm or smaller.

105. A thermal fuse having a function of a current fuse according to claim 33, wherein a thickness from a lower face of said resin base film to an upper face of said resin cover film is 2.0 mm or smaller.

106. A thermal fuse having a function of a current fuse according to claim 34, wherein a thickness from a lower face of said resin base film to an upper face of said resin cover film is 2.0 mm or smaller.

107. A thermal fuse having a function of a current fuse according to claim 35, wherein a thickness from a lower face of said resin base film to an upper face of said resin cover film is 2.0 mm or smaller.

108. A thermal fuse having a function of a current fuse according to claim 36, wherein a thickness from a lower face of said resin base film to an upper face of said resin cover film is 2.0 mm or smaller.

109. A thermal fuse having a function of a current fuse according to claim 37, wherein a thickness from a lower face of said resin base film to an upper face of said resin cover film is 2.0 mm or smaller.

110. A thermal fuse having a function of a current fuse according to claim 38, wherein a thickness from a lower face of said resin base film to an upper face of said resin cover film is 2.0 mm or smaller.

111. A thermal fuse having a function of a current fuse according to claim 39, wherein a thickness from a lower face of said resin base film to an upper face of said resin cover film is 2.0 mm or smaller.

112. A thermal fuse having a function of a current fuse according to claim 40, wherein a thickness from a lower face of said resin base film to an upper face of said resin cover film is 2.0 mm or smaller.

113. A thermal fuse having a function of a current fuse according to claim 41, wherein a thickness from a lower face of said resin base film to an upper face of said resin cover film is 2.0 mm or smaller.

114. A thermal fuse having a function of a current fuse according to claim 42, wherein a thickness from a lower face of said resin base film to an upper face of said resin cover film is 2.0 mm or smaller.

115. A thermal fuse having a function of a current fuse according to claim 43, wherein a thickness from a lower face of said resin base film to an upper face of said resin cover film is 2.0 mm or smaller.

116. A thermal fuse having a function of a current fuse according to claim 44, wherein a thickness from a lower face of said resin base film to an upper face of said resin cover film is 2.0 mm or smaller.

117. A thermal fuse having a function of a current fuse according to claim 45, wherein a thickness from a lower face of said resin base film to an upper face of said resin cover film is 2.0 mm or smaller.

118. A thermal fuse having a function of a current fuse according to claim 46, wherein a thickness from a lower face of said resin base film to an upper face of said resin cover film is 2.0 mm or smaller.

119. A thermal fuse having a function of a current fuse according to claim 47, wherein a thickness from a lower face of said resin base film to an upper face of said resin cover film is 2.0 mm or smaller.

120. A thermal fuse having a function of a current fuse according to claim 48, wherein a thickness from a lower face of said resin base film to an upper face of said resin cover film is 2.0 mm or smaller.

121. A thermal fuse having a function of a current fuse according to claim 49, wherein a thickness from a lower face of said resin base film to an upper face of said resin cover film is 2.0 mm or smaller.

122. A thermal fuse having a function of a current fuse according to claim 50, wherein a thickness from a lower face of said resin base film to an upper face of said resin cover film is 2.0 mm or smaller.

123. A thermal fuse having a function of a current fuse according to claim 51, wherein a thickness from a lower face of said resin base film to an upper face of said resin cover film is 2.0 mm or smaller.

124. A thermal fuse having a function of a current fuse according to claim 52, wherein a thickness from a lower face of said resin base film to an upper face of said resin cover film is 2.0 mm or smaller.

125. A thermal fuse having a function of a current fuse according to claim 53, wherein a thickness from a lower face of said resin base film to an upper face of said resin cover film is 2.0 mm or smaller.

126. A thermal fuse having a function of a current fuse according to claim 54, wherein a thickness from a lower face of said resin base film to an upper face of said resin cover film is 2.0 mm or smaller.

127. A thermal fuse having a function of a current fuse according to claim 55, wherein a thickness from a lower face of said resin base film to an upper face of said resin cover film is 2.0 mm or smaller.

128. A thermal fuse having a function of a current fuse according to claim 56, wherein a thickness from a lower face of said resin base film to an upper face of said resin cover film is 2.0 mm or smaller.

129. A thermal fuse having a function of a current fuse according to claim 57, wherein a thickness from a lower face of said resin base film to an upper face of said resin cover film is 2.0 mm or smaller.

130. A thermal fuse having a function of a current fuse according to claim 58, wherein a thickness from a lower face of said resin base film to an upper face of said resin cover film is 2.0 mm or smaller.

131. A thermal fuse having a function of a current fuse according to claim 59, wherein a thickness from a lower face of said resin base film to an upper face of said resin cover film is 2.0 mm or smaller.

132. A thermal fuse having a function of a current fuse according to claim 60, wherein a thickness from a lower face of said resin base film to an upper face of said resin cover film is 2.0 mm or smaller.

133. A thermal fuse having a function of a current fuse according to claim 61, wherein a thickness from a lower face of said resin base film to an upper face of said resin cover film is 2.0 mm or smaller.

134. A thermal fuse having a function of a current fuse according to claim 62, wherein a thickness from a lower face of said resin base film to an upper face of said resin cover film is 2.0 mm or smaller.

135. A thermal fuse having a function of a current fuse according to claim 63, wherein a thickness from a lower face of said resin base film to an upper face of said resin cover film is 2.0 mm or smaller.

136. A thermal fuse having a function of a current fuse according to claim 64, wherein a thickness from a lower face of said resin base film to an upper face of said resin cover film is 2.0 mm or smaller.

137. A thermal fuse having a function of a current fuse according to claim 65, wherein a thickness from a lower face of said resin base film to an upper face of said resin cover film is 2.0 mm or smaller.

138. A thermal fuse having a function of a current fuse according to claim 66, wherein a thickness from a lower face of said resin base film to an upper face of said resin cover film is 2.0 mm or smaller.

139. A thermal fuse having a function of a current fuse according to claim 67, wherein a thickness from a lower face of said resin base film to an upper face of said resin cover film is 2.0 mm or smaller.

140. A thermal fuse having a function of a current fuse according to claim 68, wherein a thickness from a lower face of said resin base film to an upper face of said resin cover film is 2.0 mm or smaller.

141. A thermal fuse having a function of a current fuse according to claim 69, wherein a thickness from a lower face of said resin base film to an upper face of said resin cover film is 2.0 mm or smaller.

142. A thermal fuse having a function of a current fuse according to claim 70, wherein a thickness from a lower face of said resin base film to an upper face of said resin cover film is 2.0 mm or smaller.

143. A thermal fuse having a function of a current fuse according to claim 71, wherein a thickness from a lower face of said resin base film to an upper face of said resin cover film is 2.0 mm or smaller.

144. A thermal fuse having a function of a current fuse according to claim 72, wherein a thickness from a lower face of said resin base film to an upper face of said resin cover film is 2.0 mm or smaller.

145. A thermal fuse having a function of a current fuse according to claim 1, wherein said flat lead conductors are made of nickel or an iron alloy.

146. A thermal fuse having a function of a current fuse according to claim 2, wherein said flat lead conductors are made of nickel or an iron alloy.

147. A thermal fuse having a function of a current fuse according to claim 3, wherein said flat lead conductors are made of nickel or an iron alloy.

148. A thermal fuse having a function of a current fuse according to claim 4, wherein said flat lead conductors are made of nickel or an iron alloy.

149. A thermal fuse having a function of a current fuse according to claim 5, wherein said flat lead conductors are made of nickel or an iron alloy.

150. A thermal fuse having a function of a current fuse according to claim 6, wherein said flat lead conductors are made of nickel or an iron alloy.

151. A thermal fuse having a function of a current fuse according to claim 7, wherein said flat lead conductors are made of nickel or an iron alloy.

152. A thermal fuse having a function of a current fuse according to claim 8, wherein said flat lead conductors are made of nickel or an iron alloy.

153. A thermal fuse having a function of a current fuse according to claim 9, wherein said flat lead conductors are made of nickel or an iron alloy.

154. A thermal fuse having a function of a current fuse according to claim 10, wherein said flat lead conductors are made of nickel or an iron alloy.

155. A thermal fuse having a function of a current fuse according to claim 11, wherein said flat lead conductors are made of nickel or an iron alloy.

156. A thermal fuse having a function of a current fuse according to claim 12, wherein said flat lead conductors are made of nickel or an iron alloy.

157. A thermal fuse having a function of a current fuse according to claim 13, wherein said flat lead conductors are made of nickel or an iron alloy.

158. A thermal fuse having a function of a current fuse according to claim 14, wherein said flat lead conductors are made of nickel or an iron alloy.

159. A thermal fuse having a function of a current fuse according to claim 15, wherein said flat lead conductors are made of nickel or an iron alloy.

160. A thermal fuse having a function of a current fuse according to claim 16, wherein said flat lead conductors are made of nickel or an iron alloy.

161. A thermal fuse having a function of a current fuse according to claim 17, wherein said flat lead conductors are made of nickel or an iron alloy.

162. A thermal fuse having a function of a current fuse according to claim 18, wherein said flat lead conductors are made of nickel or an iron alloy.

163. A thermal fuse having a function of a current fuse according to claim 19, wherein said flat lead conductors are made of nickel or an iron alloy.

164. A thermal fuse having a function of a current fuse according to claim 20, wherein said flat lead conductors are made of nickel or an iron alloy.

165. A thermal fuse having a function of a current fuse according to claim 21, wherein said flat lead conductors are made of nickel or an iron alloy.

166. A thermal fuse having a function of a current fuse according to claim 22, wherein said flat lead conductors are made of nickel or an iron alloy.

167. A thermal fuse having a function of a current fuse according to claim 23, wherein said flat lead conductors are made of nickel or an iron alloy.

168. A thermal fuse having a function of a current fuse according to claim 24, wherein said flat lead conductors are made of nickel or an iron alloy.

169. A thermal fuse having a function of a current fuse according to claim 25, wherein said flat lead conductors are made of nickel or an iron alloy.

170. A thermal fuse having a function of a current fuse according to claim 26, wherein said flat lead conductors are made of nickel or an iron alloy.

171. A thermal fuse having a function of a current fuse according to claim 27, wherein said flat lead conductors are made of nickel or an iron alloy.

172. A thermal fuse having a function of a current fuse according to claim 28, wherein said flat lead conductors are made of nickel or an iron alloy.

173. A thermal fuse having a function of a current fuse according to claim 29, wherein said flat lead conductors are made of nickel or an iron alloy.

174. A thermal fuse having a function of a current fuse according to claim 30, wherein said flat lead conductors are made of nickel or an iron alloy.

175. A thermal fuse having a function of a current fuse according to claim 31, wherein said flat lead conductors are made of nickel or an iron alloy.

176. A thermal fuse having a function of a current fuse according to claim 32, wherein said flat lead conductors are made of nickel or an iron alloy.

177. A thermal fuse having a function of a current fuse according to claim 33, wherein said flat lead conductors are made of nickel or an iron alloy.

178. A thermal fuse having a function of a current fuse according to claim 34, wherein said flat lead conductors are made of nickel or an iron alloy.

179. A thermal fuse having a function of a current fuse according to claim 35, wherein said flat lead conductors are made of nickel or an iron alloy.

180. A thermal fuse having a function of a current fuse according to claim 36, wherein said flat lead conductors are made of nickel or an iron alloy.

181. A thermal fuse having a function of a current fuse according to claim 37, wherein said flat lead conductors are made of nickel or an iron alloy.

182. A thermal fuse having a function of a current fuse according to claim 38, wherein said flat lead conductors are made of nickel or an iron alloy.

183. A thermal fuse having a function of a current fuse according to claim 39, wherein said flat lead conductors are made of nickel or an iron alloy.

184. A thermal fuse having a function of a current fuse according to claim 40, wherein said flat lead conductors are made of nickel or an iron alloy.

185. A thermal fuse having a function of a current fuse according to claim 41, wherein said flat lead conductors are made of nickel or an iron alloy.

186. A thermal fuse having a function of a current fuse according to claim 42, wherein said flat lead conductors are made of nickel or an iron alloy.

187. A thermal fuse having a function of a current fuse according to claim 43, wherein said flat lead conductors are made of nickel or an iron alloy.

188. A thermal fuse having a function of a current fuse according to claim 44, wherein said flat lead conductors are made of nickel or an iron alloy.

189. A thermal fuse having a function of a current fuse according to claim 45, wherein said flat lead conductors are made of nickel or an iron alloy.

190. A thermal fuse having a function of a current fuse according to claim 46, wherein said flat lead conductors are made of nickel or an iron alloy.

191. A thermal fuse having a function of a current fuse according to claim 47, wherein said flat lead conductors are made of nickel or an iron alloy.

192. A thermal fuse having a function of a current fuse according to claim 48, wherein said flat lead conductors are made of nickel or an iron alloy.

193. A thermal fuse having a function of a current fuse according to claim 49, wherein said flat lead conductors are made of nickel or an iron alloy.

194. A thermal fuse having a function of a current fuse according to claim 50, wherein said flat lead conductors are made of nickel or an iron alloy.

195. A thermal fuse having a function of a current fuse according to claim 51, wherein said flat lead conductors are made of nickel or an iron alloy.

196. A thermal fuse having a function of a current fuse according to claim 52, wherein said flat lead conductors are made of nickel or an iron alloy.

197. A thermal fuse having a function of a current fuse according to claim 53, wherein said flat lead conductors are made of nickel or an iron alloy.

198. A thermal fuse having a function of a current fuse according to claim 54, wherein said flat lead conductors are made of nickel or an iron alloy.

199. A thermal fuse having a function of a current fuse according to claim 55, wherein said flat lead conductors are made of nickel or an iron alloy.

200. A thermal fuse having a function of a current fuse according to claim 56, wherein said flat lead conductors are made of nickel or an iron alloy.

201. A thermal fuse having a function of a current fuse according to claim 57, wherein said flat lead conductors are made of nickel or an iron alloy.

202. A thermal fuse having a function of a current fuse according to claim 58, wherein said flat lead conductors are made of nickel or an iron alloy.

203. A thermal fuse having a function of a current fuse according to claim 59, wherein said flat lead conductors are made of nickel or an iron alloy.

204. A thermal fuse having a function of a current fuse according to claim 60, wherein said flat lead conductors are made of nickel or an iron alloy.

205. A thermal fuse having a function of a current fuse according to claim 61, wherein said flat lead conductors are made of nickel or an iron alloy.

206. A thermal fuse having a function of a current fuse according to claim 62, wherein said flat lead conductors are made of nickel or an iron alloy.

207. A thermal fuse having a function of a current fuse according to claim 63, wherein said flat lead conductors are made of nickel or an iron alloy.

208. A thermal fuse having a function of a current fuse according to claim 64, wherein said flat lead conductors are made of nickel or an iron alloy.

209. A thermal fuse having a function of a current fuse according to claim 65, wherein said flat lead conductors are made of nickel or an iron alloy.

210. A thermal fuse having a function of a current fuse according to claim 66, wherein said flat lead conductors are made of nickel or an iron alloy.

211. A thermal fuse having a function of a current fuse according to claim 67, wherein said flat lead conductors are made of nickel or an iron alloy.

212. A thermal fuse having a function of a current fuse according to claim 68, wherein said flat lead conductors are made of nickel or an iron alloy.

213. A thermal fuse having a function of a current fuse according to claim 69, wherein said flat lead conductors are made of nickel or an iron alloy.

214. A thermal fuse having a function of a current fuse according to claim 70, wherein said flat lead conductors are made of nickel or an iron alloy.

215. A thermal fuse having a function of a current fuse according to claim 71, wherein said flat lead conductors are made of nickel or an iron alloy.

216. A thermal fuse having a function of a current fuse according to claim 72, wherein said flat lead conductors are made of nickel or an iron alloy.

217. A thermal fuse having a function of a current fuse according to claim 73, wherein said flat lead conductors are made of nickel or an iron alloy.

218. A thermal fuse having a function of a current fuse according to claim 74, wherein said flat lead conductors are made of nickel or an iron alloy.

219. A thermal fuse having a function of a current fuse according to claim 75, wherein said flat lead conductors are made of nickel or an iron alloy.

220. A thermal fuse having a function of a current fuse according to claim 76, wherein said flat lead conductors are made of nickel or an iron alloy.

221. A thermal fuse having a function of a current fuse according to claim 77, wherein said flat lead conductors are made of nickel or an iron alloy.

222. A thermal fuse having a function of a current fuse according to claim 78, wherein said flat lead conductors are made of nickel or an iron alloy.

223. A thermal fuse having a function of a current fuse according to claim 79, wherein said flat lead conductors are made of nickel or an iron alloy.

224. A thermal fuse having a function of a current fuse according to claim 80, wherein said flat lead conductors are made of nickel or an iron alloy.

225. A thermal fuse having a function of a current fuse according to claim 81, wherein said flat lead conductors are made of nickel or an iron alloy.

226. A thermal fuse having a function of a current fuse according to claim 82, wherein said flat lead conductors are made of nickel or an iron alloy.

227. A thermal fuse having a function of a current fuse according to claim 83, wherein said flat lead conductors are made of nickel or an iron alloy.

228. A thermal fuse having a function of a current fuse according to claim 84, wherein said flat lead conductors are made of nickel or an iron alloy.

229. A thermal fuse having a function of a current fuse according to claim 85, wherein said flat lead conductors are made of nickel or an iron alloy.

230. A thermal fuse having a function of a current fuse according to claim 86, wherein said flat lead conductors are made of nickel or an iron alloy.

231. A thermal fuse having a function of a current fuse according to claim 87, wherein said flat lead conductors are made of nickel or an iron alloy.

232. A thermal fuse having a function of a current fuse according to claim 88, wherein said flat lead conductors are made of nickel or an iron alloy.

233. A thermal fuse having a function of a current fuse according to claim 89, wherein said flat lead conductors are made of nickel or an iron alloy.

234. A thermal fuse having a function of a current fuse according to claim 90, wherein said flat lead conductors are made of nickel or an iron alloy.

235. A thermal fuse having a function of a current fuse according to claim 91, wherein said flat lead conductors are made of nickel or an iron alloy.

236. A thermal fuse having a function of a current fuse according to claim 92, wherein said flat lead conductors are made of nickel or an iron alloy.

237. A thermal fuse having a function of a current fuse according to claim 93, wherein said flat lead conductors are made of nickel or an iron alloy.

238. A thermal fuse having a function of a current fuse according to claim 94, wherein said flat lead conductors are made of nickel or an iron alloy.

239. A thermal fuse having a function of a current fuse according to claim 95, wherein said flat lead conductors are made of nickel or an iron alloy.

240. A thermal fuse having a function of a current fuse according to claim 96, wherein said flat lead conductors are made of nickel or an iron alloy.

241. A thermal fuse having a function of a current fuse according to claim 97, wherein said flat lead conductors are made of nickel or an iron alloy.

242. A thermal fuse having a function of a current fuse according to claim 98, wherein said flat lead conductors are made of nickel or an iron alloy.

243. A thermal fuse having a function of a current fuse according to claim 99, wherein said flat lead conductors are made of nickel or an iron alloy.

244. A thermal fuse having a function of a current fuse according to claim 100, wherein said flat lead conductors are made of nickel or an iron alloy.

245. A thermal fuse having a function of a current fuse according to claim 101, wherein said flat lead conductors are made of nickel or an iron alloy.

246. A thermal fuse having a function of a current fuse according to claim 102, wherein said flat lead conductors are made of nickel or an iron alloy.

247. A thermal fuse having a function of a current fuse according to claim 103, wherein said flat lead conductors are made of nickel or an iron alloy.

248. A thermal fuse having a function of a current fuse according to claim 104, wherein said flat lead conductors are made of nickel or an iron alloy.

249. A thermal fuse having a function of a current fuse according to claim 105, wherein said flat lead conductors are made of nickel or an iron alloy.

250. A thermal fuse having a function of a current fuse according to claim 106, wherein said flat lead conductors are made of nickel or an iron alloy.

251. A thermal fuse having a function of a current fuse according to claim 107, wherein said flat lead conductors are made of nickel or an iron alloy.

252. A thermal fuse having a function of a current fuse according to claim 108, wherein said flat lead conductors are made of nickel or an iron alloy.

253. A thermal fuse having a function of a current fuse according to claim 109, wherein said flat lead conductors are made of nickel or an iron alloy.

254. A thermal fuse having a function of a current fuse according to claim 110, wherein said flat lead conductors are made of nickel or an iron alloy.

255. A thermal fuse having a function of a current fuse according to claim 111, wherein said flat lead conductors are made of nickel or an iron alloy.

256. A thermal fuse having a function of a current fuse according to claim 112, wherein said flat lead conductors are made of nickel or an iron alloy.

257. A thermal fuse having a function of a current fuse according to claim 113, wherein said flat lead conductors are made of nickel or an iron alloy.

258. A thermal fuse having a function of a current fuse according to claim 114, wherein said flat lead conductors are made of nickel or an iron alloy.

259. A thermal fuse having a function of a current fuse according to claim 115, wherein said flat lead conductors are made of nickel or an iron alloy.

260. A thermal fuse having a function of a current fuse according to claim 116, wherein said flat lead conductors are made of nickel or an iron alloy.

261. A thermal fuse having a function of a current fuse according to claim 117, wherein said flat lead conductors are made of nickel or an iron alloy.

262. A thermal fuse having a function of a current fuse according to claim 118, wherein said flat lead conductors are made of nickel or an iron alloy.

263. A thermal fuse having a function of a current fuse according to claim 119, wherein said flat lead conductors are made of nickel or an iron alloy.

264. A thermal fuse having a function of a current fuse according to claim 120, wherein said flat lead conductors are made of nickel or an iron alloy.

265. A thermal fuse having a function of a current fuse according to claim 121, wherein said flat lead conductors are made of nickel or an iron alloy.

266. A thermal fuse having a function of a current fuse according to claim 122, wherein said flat lead conductors are made of nickel or an iron alloy.

267. A thermal fuse having a function of a current fuse according to claim 123, wherein said flat lead conductors are made of nickel or an iron alloy.

268. A thermal fuse having a function of a current fuse according to claim 124, wherein said flat lead conductors are made of nickel or an iron alloy.

269. A thermal fuse having a function of a current fuse according to claim 125, wherein said flat lead conductors are made of nickel or an iron alloy.

270. A thermal fuse having a function of a current fuse according to claim 126, wherein said flat lead conductors are made of nickel or an iron alloy.

271. A thermal fuse having a function of a current fuse according to claim 127, wherein said flat lead conductors are made of nickel or an iron alloy.

272. A thermal fuse having a function of a current fuse according to claim 128, wherein said flat lead conductors are made of nickel or an iron alloy.

273. A thermal fuse having a function of a current fuse according to claim 129, wherein said flat lead conductors are made of nickel or an iron alloy.

274. A thermal fuse having a function of a current fuse according to claim 130, wherein said flat lead conductors are made of nickel or an iron alloy.

275. A thermal fuse having a function of a current fuse according to claim 131, wherein said flat lead conductors are made of nickel or an iron alloy.

276. A thermal fuse having a function of a current fuse according to claim 132, wherein said flat lead conductors are made of nickel or an iron alloy.

277. A thermal fuse having a function of a current fuse according to claim 133, wherein said flat lead conductors are made of nickel or an iron alloy.

278. A thermal fuse having a function of a current fuse according to claim 134, wherein said flat lead conductors are made of nickel or an iron alloy.

279. A thermal fuse having a function of a current fuse according to claim 135, wherein said flat lead conductors are made of nickel or an iron alloy.

280. A thermal fuse having a function of a current fuse according to claim 136, wherein said flat lead conductors are made of nickel or an iron alloy.

281. A thermal fuse having a function of a current fuse according to claim 137, wherein said flat lead conductors are made of nickel or an iron alloy.

282. A thermal fuse having a function of a current fuse according to claim 138, wherein said flat lead conductors are made of nickel or an iron alloy.

283. A thermal fuse having a function of a current fuse according to claim 139, wherein said flat lead conductors are made of nickel or an iron alloy.

284. A thermal fuse having a function of a current fuse according to claim 140, wherein said flat lead conductors are made of nickel or an iron alloy.

285. A thermal fuse having a function of a current fuse according to claim 141, wherein said flat lead conductors are made of nickel or an iron alloy.

286. A thermal fuse having a function of a current fuse according to claim 142, wherein said flat lead conductors are made of nickel or an iron alloy.

287. A thermal fuse having a function of a current fuse according to claim 143, wherein said flat lead conductors are made of nickel or an iron alloy.

288. A thermal fuse having a function of a current fuse according to claim 144, wherein said flat lead conductors are made of nickel or an iron alloy.
